(19) United States
(12) Patent Application Publication
(10) Pub. No.: US 2020/0355195 A1
(43) Pub. Date: Nov. 12, 2020

(54) FLUID PUMP

(71) Applicant: MAHLE International GmbH, Stuttgart (DE)

(72) Inventors: Johannes Diekmann, Schorndorf (DE); Eugen Makarow, Ludwigsburg (DE); Andrej Rul, Stuttgart (DE); Benjamin Weimann, Stuttgart (DE)

(21) Appl. No.: 16/868,496

(22) Filed: May 6, 2020

(30) Foreign Application Priority Data
May 7, 2019 (DE) 10 2019 206 548.1

(51) Int. Cl. F04D 29/22; F04D 13/06

(52) U.S. Cl. CPC F04D 29/2222; F05B 2240/30; F04D 13/06

(57) ABSTRACT

A fluid pump includes an internal rotor rotatable about an axis of rotation and having a non-rotatable external stator and an impeller having multiple blades axially arranged between a support disc and a cover disc. The rotor has a rotor housing having a base, a mounting sleeve and a cover, in which an armature unit of the rotor is received so as to be fluid-tight towards the outside. The support disc of the impeller forms the cover of the rotor housing and axially seals the mounting sleeve. The impeller includes a first part and a second part which are fixed to one another in a material bonded manner. Here, the blades are exclusively formed integrally on the first part or on the second part, axially project from this part on one side and are axially covered by the respective other part.

### CROSS REFERENCE TO RELATED APPLICATIONS

This application claims priority to German patent application DE 10 2019 206 548.1, filed May 7, 2019, the entire content of which is incorporated herein by reference.

### TECHNICAL FIELD

The disclosure relates to a fluid pump having a rotatable internal rotor and a non-rotatable external stator.

### BACKGROUND

A generic fluid pump is described for example in WO 2018 162 282 A1. The pump includes a rotatable internal rotor and a non-rotatable external stator. The rotor has a can-shaped rotor housing, in which an armature unit of the rotor is received fluid-tight towards the outside. In addition, an impeller having multiple blades is arranged in the rotor housing, which are axially formed between a support disc and a cover disc. The impeller can be produced by plastic injection molding. Disadvantageously, the geometry and the choice of material of the impeller is restricted by the manufacturing process. Because of this, an optimization of the pumping behavior of the fluid pump is not easily possible.

### SUMMARY

It is therefore an object of the disclosure to provide an improved or at least alternative embodiment for a fluid pump of the generic type, in which the described disadvantages are overcome.

The object is achieved by a fluid pump as described herein.

A generic fluid pump includes an impeller rotor that is rotatable about an axis of rotation and a non-rotatable external stator. The fluid pump includes an impeller with multiple blades which are axially arranged on a support disc and on a cover disc. The rotor includes a rotor housing with a base, a mounting sleeve and a cover, in which an armature unit of the rotor is received fluid-tight towards the outside. The support disc of the impeller forms the cover of the rotor housing and axially seals the mounting sleeve. According to an aspect of the disclosure, the impeller includes a first part and a second part which are fixed to one another in a material bonded manner. Furthermore, the blades are exclusively molded integrally on the first part or on the second part. Here, the blades project unilaterally from this part and are axially covered by the respective other part. The terms “axial” and “radial” refer, here and in the following, to the axis of rotation about which the rotor of the fluid pump is rotatable.

In the fluid pump according to an aspect of the disclosure, the impeller is formed in two parts and can, compared with a conventional impeller, have a more complex geometry. In other words, more degrees of freedoms are available when designing the impeller in the fluid pump according to an aspect of the disclosure. Furthermore, the first part and the second part of the impeller can be formed from different materials, so that the choice of material can also be expanded, and the manufacturing costs reduced. In particular, the individual parts of the impeller can each be produced as injection molded parts since each individual part can be realized in an easily demoldable manner. Here, the joined impeller can have a complex geometry so that the impeller as such is only demoldable with difficulty or not at all and accordingly can only be produced by injection molding with major expenditure or not at all. Advantageously, the fluid pump can be an electric liquid pump.

In an advantageous configuration of the fluid pump, it is provided that the first part is formed by the support disc. The second part is then formed by the cover disc and the blades that are integrally formed on the cover disc and a center part of the impeller integrally formed on the blades. The blades and the center part are fixed to the support disc and thus the second part to the first part in a material bonded manner. Thus, the blades are arranged between the center part and the cover disc and integrally connect these to one another. The center part is arranged circularly and about the axis of rotation of the rotor, so that the disc-shaped cover disc, axially spaced apart, circulates about the center part. Here, the center part, facing away from the blades, axially lies against the support disc and can both support the blades during the assembly and also make possible a secure fixing of the second part to the first part. In an alternative configuration of the fluid pump, it is provided that the first part is formed by the support disc and a center part of the impeller integrally formed on the support disc and the blades integrally formed on the support disc and on the center part. The second part is then formed by the cover disc. Here, the blades are fixed to the cover disc and thus the first part to the second part in a material bonded manner. Here, the center part lies axially against the support disc and integrally merges into the support disc radially to the outside, so that the blades project from the support disc and from the center part unilaterally to the cover disc. Because of this, the blades are unilaterally exposed on the first part and the support disc and the center part are indirectly fixed to the cover disc via the blades. Advantageously, it can be provided that the first part and the second part of the impeller are fixed to one another in a material bonded manner by way of ultrasound welding or by friction welding.

In an advantageous further exemplary embodiment of the fluid pump it is provided that the mounting sleeve of the rotor housing is integrally formed on the support disc and the base axially seals the mounting sleeve. Prior to the closing of the mounting sleeve, the base is practically disconnected from the same and, following the mounting of the armature unit in the mounting sleeve, can be fixed to the same. In particular, the base can be fixed to the mounting sleeve in a material bonded manner by way of ultrasound welding or by friction welding. In other words, the rotor housing is formed by a one-part or one-piece can and the base fixed to the same. The one-part or one-piece can is formed by the mounting sleeve and the support disc. The blades of the impeller can be integrally formed on the support disc and thus on the one-part or one-piece can. The one-part or one-piece can with the blades integrally formed on the same then constitutes the single complex component and the base and the cover disc can be configured and produced in a relatively simple manner. Because of this, the process reliability during the material bonded fixing of the cover disc to the blades of the impeller and of the base on the mounting sleeve can be increased. Alternatively, the blades can also be integrally formed on the cover disc and the geometry of the one-part or one-piece can thereby simplified.

In an alternative further exemplary embodiment of the fluid pump, it is provided that the mounting sleeve and the base of the rotor housing are internally formed on one another and the support disc axially seals the mounting sleeve. Here, the support disc is practically disconnected from the mounting sleeve prior to the closing of the same and, after the mounting of the armature unit in the mounting sleeve, can be fixed to the same. In particular, the support disc can be fixed to the mounting sleeve in a material bonded manner by ultrasound welding or by friction welding. In other words, the rotor housing is formed by a one-part or one-piece can and the support disc fixed to the same. The one-part or one-piece can is formed by the mounting sleeve and the base. The blades of the impeller can be integrally formed on the support disc or on the cover disc.

Advantageously, it can be provided that in a center part of the impeller circulating about the axis of rotation, a bearing is arranged, in which a shaft of the fluid pump is mounted. Here, the bearing can be fixed in the center part of the impeller by a form-fitting unit in a form-fitting and non-rotatable manner. Here, the center part can be configured as described above and be an integral part of the first part of the impeller or of the second part of the impeller. Here, the blades are fixed unilaterally in regions to the center part and to the support disc and on the other side to the cover disc. The center part circulates about the axis of rotation of the rotor and is circular. Additionally or alternatively, the bearing and the center part can be fixed to one another in a material bonded and non-rotatable manner for example by ultrasound welding or by friction welding. It is also conceivable that the bearing is overmolded and because of this the center part is molded about the bearing. When overmolding the bearing, the bearing is then also fixed in the center part in a material bonded and non-rotatable manner. Alternatively, the center part can be formed from a sliding bearing material and the bearing integrally formed in the center part or in one piece with the same. Since the support disc and/or the cover disc and thus the center part are producible from different materials, no substantial additional costs are incurred because of this.

Advantageously, at least one assembly recess can be formed on the impeller face end facing away from the rotor, which is arranged parallel to and spaced apart from the axis of rotation of the rotor. The respective assembly recess can be introduced into the support disc or into the cover disc or into the bearing or into the center part. The respective assembly recess is practically accessible from the outside facing away from the rotor, so that a tool can engage in the same. This can be effected for example during the assembly of the fluid pump and in particular during the friction welding of the support disc to the mounting sleeve or of the base to the mounting sleeve or of the first part to the second part or of the bearing to the center part, no rotation-preventing form-fitting unit is then practically provided here. Advantageously, multiple assembly recesses can also be provided, which are arranged, circulating about and spaced apart from the axis of rotation of the rotor, in the impeller. Advantageously, the respective assembly recesses can then be formed in the support disc and/or in the cover disc and/or in the bearing and/or in the center part. In particular, the respective multiple assembly recesses can be arranged on the respective constituent part of the impeller at a same distance from one another and circulating about the axis of rotation, in order to make possible an even transmission of the torque from the tool to the respective constituent part of the impeller during the assembly and in particular during the friction welding.

Further important features and advantages of the disclosure are obtained from the drawings and from the associated figure description.

It is to be understood that the features mentioned above and still to be explained in the following cannot only be used in the respective combination stated but also in other combinations or by themselves without leaving the scope of the present disclosure.

Exemplary embodiments of the disclosure are shown in the drawings and are explained in more detail in the following description, wherein same reference numbers relate to same or similar or functionally same components.

### BRIEF DESCRIPTION OF THE DRAWINGS

The disclosure will now be described with reference to the drawings wherein:

FIG. 1 shows a sectional view of a fluid pump according to a first embodiment of the disclosure;

FIGS. 2 and 3 show views of a rotor and of an impeller of the fluid pump according to the first exemplary embodiment of the disclosure;

FIG. 4 shows a sectional view of the rotor and of the impeller of the fluid pump according to the first exemplary embodiment the disclosure;

FIGS. 5 and 6 show exploded views of the rotor and of the impeller of the fluid pump according to the first exemplary embodiment of the disclosure;

FIG. 7 shows a sectional view of the rotor and of the impeller of the fluid pump according to a second exemplary embodiment of the disclosure; and

FIGS. 8 and 9 show exploded views of the rotor and of the impeller of the fluid pump according to the second exemplary embodiment of the disclosure.

### DESCRIPTION OF EXEMPLARY EMBODIMENTS

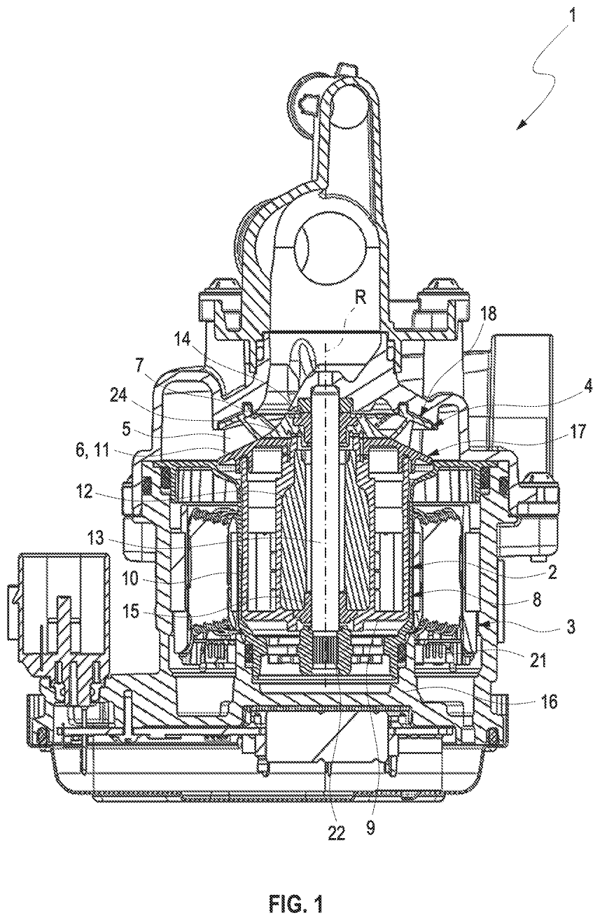

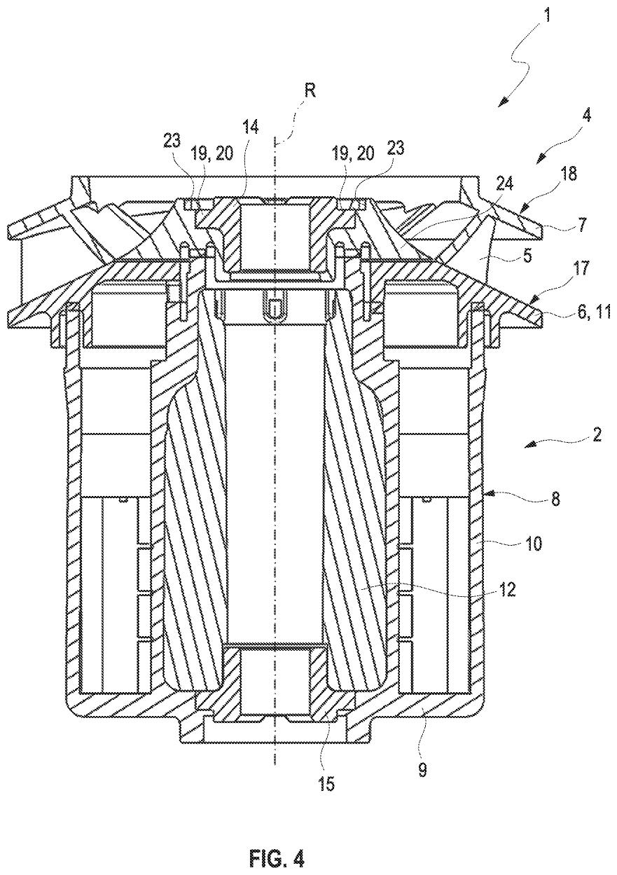

FIG. 1 shows a sectional view of a fluid pump 1 according to a first exemplary embodiment of the disclosure. Here, the fluid pump 1 includes a rotatable rotor 2 and a non-rotatable stator 3. The rotor 2 is rotatably arranged within the stator 3 so as to be rotatable in the same about an axis of rotation R. Furthermore, the fluid pump 1 includes an impeller 4, which is non-rotatably fixed to the rotor 2. An enlarged sectional view of the rotor 2 and of the impeller 4 is shown in FIG. 4. The impeller 4 includes multiple blades 5 which are axially arranged between a support disc 6 and a center part 24 of the impeller 4 and a cover disc 7. The rotor comprises a rotor housing 8 which comprises a base 9, a mounting sleeve 10 and a cover 11. The base 9 and the cover 11 seal the mounting sleeve 10 axially in a fluid-tight manner. The cover 11 of the rotor housing 8 is formed by the support disc 6 of the impeller 4, as a result of which the impeller 4 is non-rotatably fixed to the rotor 2 and with the same rotatably in the stator 3. In the rotor housing 8, an armature unit 12 of the rotor 2 is mounted fluid-tight towards the outside, which armature unit 12 electromechanically interacts with the stator 3. Furthermore, the fluid pump 1 includes a shaft 13 which is mounted by a bearing 14 and a second bearing 15 in a pump housing 16. Here, the bearing 14 is non-rotatably fixed in the center part 24 of the impeller 4 and the second bearing 15 on the base 9 of the rotor housing 8. The shaft 13 is non-rotatably fixed in the fluid pump 16. To this end, the shaft 13 is overmolded in a spacer can 21 in the region of a knurl or a toothing 22 and the spacer can 21 and thus the shaft 13 are then non-rotatably mounted in the pump housing 16. Practically, the rotor 2 and the impeller 4 are then rotatably mounted about the shaft 13.

The impeller 4 according to the disclosure is formed in two parts and includes a first part 17 and a second part 18 which are fixed to one another in a material bonded manner. In the first exemplary embodiment of the fluid pump 1, the first part 17 is formed by the support disc 6 and the second part 18 by the cover disc 7, which on the same forms integrally molded blades 5 and the center part 24 integrally formed on the blades 5. The blades 5 and the center part 24 are fixed to the support disc 6 and thus the second part 18 to the first part 17 of the impeller 4 in a material bonded manner for example by way of ultrasound welding or by way of friction welding. In the first exemplary embodiment, the base 9 and the mounting sleeve 10 of the rotor housing 8 are additionally formed integrally on one another and the support disc 6 axially seals the mounting sleeve 10. Following the mounting of the armature unit 12 in the mounting sleeve 10, the support disc 6 can be fixed to the same in a material bonded manner by way of ultrasound welding or by way of friction welding.

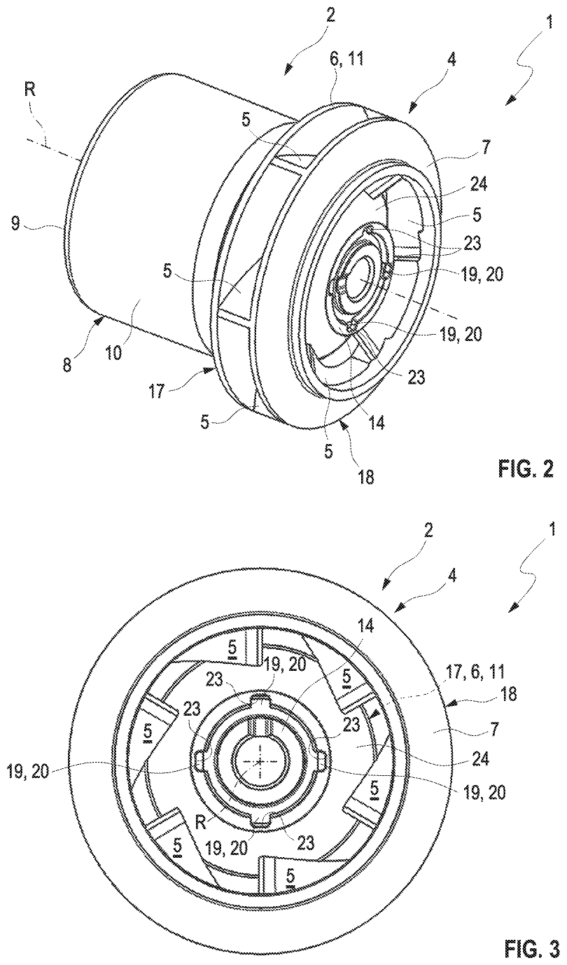

FIG. 2 and FIG. 3 show views of the rotor 2 and of the impeller 4 of the fluid pump 1 in the first exemplary embodiment. In the center part 24 of the impeller 4, the bearing 14 is fixed by a form-fitting unit 19 having multiple radially orientated projects 20 in a form-fitting and non-rotatable manner. In addition, the bearing 14 and the center part 24 of the impeller 4 can be fixed to one another in a material bonded manner by way of ultrasound welding. Alternatively, the center part 24 can also be injection-molded about the bearing 14. Furthermore, multiple assembly recesses 23 are formed on the center part 24 and thus on the impeller 4 at the phase end, which are orientated parallel to the axis of rotation R. The assembly recesses 23 circulate, spaced apart, the axis of rotation R and are provided for the engaging of a tool. This can take place for example during the assembly of the fluid pump 1 and in particular during the friction welding.

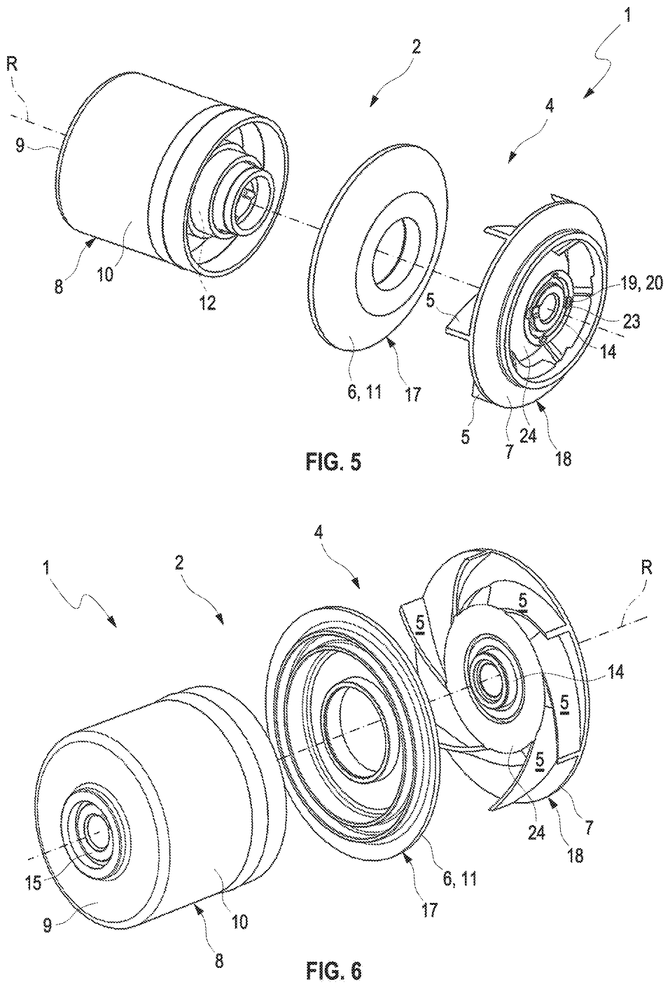

FIG. 5 and FIG. 6 show exploded views of the rotor 2 and of the impeller 4 of the fluid pump 1 in the first exemplary embodiment from different sides. As already explained above, the base 9 and the mounting sleeve 10 of the rotor housing 8 are formed in one piece. The support disc 6 then seals the mounting sleeve 10 following the mounting of the armature unit 12 and can be fixed to the mounting sleeve 10 in a form-fitting manner for example by way of ultrasound welding or by way of friction welding.

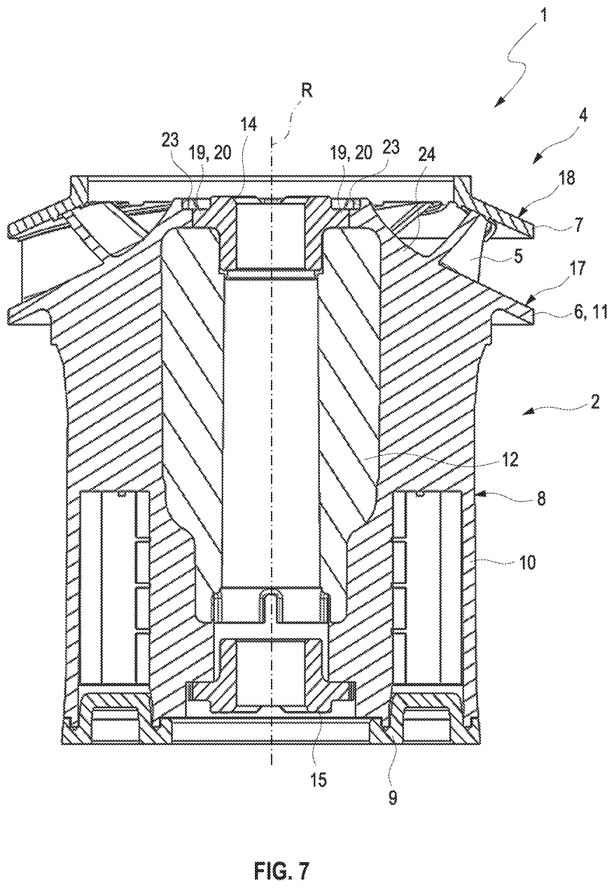

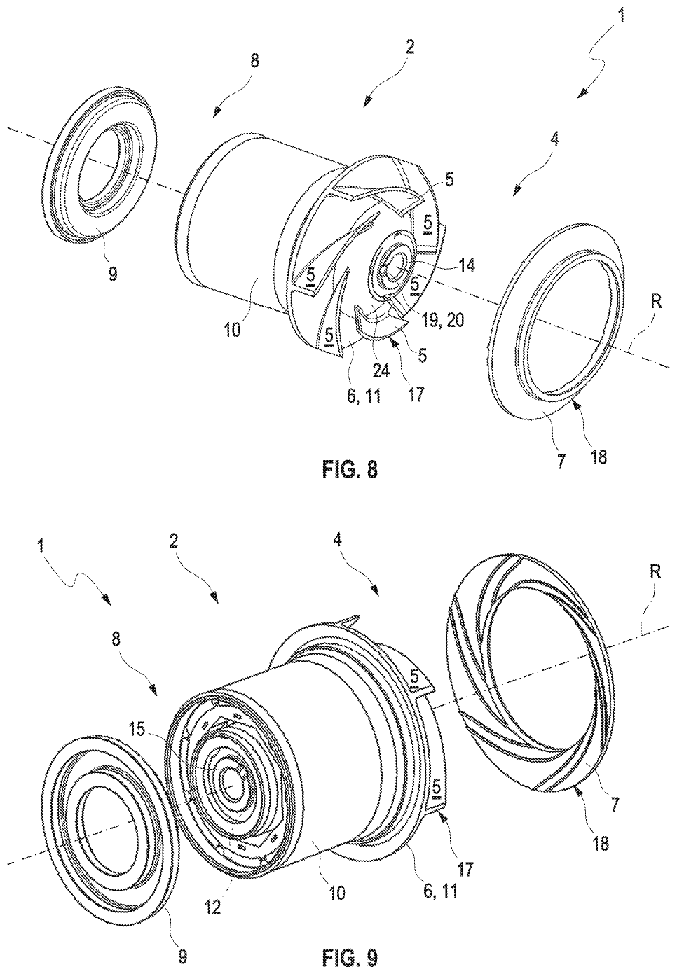

FIG. 7 shows a sectional view of the rotor 2 and of the impeller 4 of the fluid pump 1 according to a second exemplary embodiment of the disclosure. FIG. 8 and FIG. 9 show exploded views of the rotor 2 and of the impeller 4 of the fluid pump 1 in the second exemplary embodiment. In the second exemplary embodiment of the fluid pump 1, the first part 17 of the impeller 4 is formed by the support disc 6 and the blades 5 that are integrally formed on the same. The second part 18 is then formed by the cover disc 7. The blades 5 are fixed to the cover disc 7 and thus the first part 17 to the second part 18 of the impeller 4 in a form-fitting manner for example by way of ultrasound welding or by way of friction welding.

Furthermore, the support disc 6 in the fluid pump 1 in the second exemplary embodiment is formed in one piece with the mounting sleeve 10. Then, the base 9 axially seals the mounting sleeve 10 following the mounting of the armature unit and can be fixed to the mounting sleeve 10 in a form-fitting manner for example by way of ultrasound welding or by way of friction welding. In the second exemplary embodiment of the fluid pump, the mounting sleeve 10 with the first part 17 of the impeller 4 constitutes the sole complex component. The second part 18 of the impeller 4 and the base 9 of the rotor housing 8 by contrast are of a comparatively simple configuration. Because of this, the process reliability during the form-fitting fixing of the cover disc 7 to the blades 5 of the impeller 4 and of the base 9 to the mounting sleeve 10 can be increased. Otherwise, the construction of the fluid pump 1 in the second exemplary embodiment corresponds to the construction of the fluid pump 1 in the first exemplary embodiment

Summarizing, the impeller 4 of the fluid pump 1 according to the disclosure is formed in two parts so that complex geometries are realizable in the impeller 4. Furthermore, the first part 17 and the second part 18 of the impeller 4 can be formed from different materials, so that the choice of material can also be expanded and the manufacturing costs reduced. It is to be understood that further exemplary embodiments of the fluid pump 1 according to the disclosure not explicitly described here are conceivable.

What is claimed is:

1. A fluid pump comprising:
an internal rotor rotatable about an axis of rotation and having a non-rotatable external stator; and
an impeller with multiple blades which are axially arranged between a support disc and a cover disc,
wherein the rotor comprises a rotor housing having a base, a mounting sleeve and a cover, in which an armature unit of the rotor is received so as to be fluid-tight towards the outside,
wherein the support disc of the impeller forms the cover of the rotor housing and axially seals off the mounting sleeve,
wherein the impeller comprises a first part and a second part which are fixed to one another in a material bonded manner, and
wherein the blades are integrally formed exclusively on the first part or on the second part, axially project from this part unilaterally and are axially covered by the respective other part.

2. The fluid pump according to claim 1, wherein:
the first part is formed by the support disc,
the second part is formed by the cover disc and the blades that are integrally formed on the cover disc and a center part of the impeller that is integrally formed on the blades, and
the blades and the center part are fixed to the support disc and thus the second part to the first part in a material bonded manner.

3. The fluid pump according to claim 1, wherein:
the first part is formed by the support disc and by a center part of the impeller that is integrally formed on the support disc and by the blades that are integrally formed on the support disc and on the center part,
the second part is formed by the cover disc, and
the blades are fixed to the cover disc and thus the first part to the second part in a material bonded manner.

4. The fluid pump according to claim 1, wherein:
the first part and the second part of the impeller are fixed to one another in a material bonded manner by way of ultrasound welding or by way of friction welding.

5. The fluid pump according to claim 1, wherein:
the mounting sleeve of the rotor housing is integrally formed on the support disc, and
the base axially seals the mounting sleeve.

6. The fluid pump according to claim 1, wherein:
the mounting sleeve and the base of the rotor housing are integrally formed on one another, and
the support disc axially seals the mounting sleeve.

7. The fluid pump according to claim 1, wherein in a center part of the impeller circulating about the axis of rotation a bearing is arranged, in which a shaft of the fluid pump is mounted.

8. The fluid pump according to claim 7, wherein the bearing is fixed in the center part of the impeller by a form-fitting unit in a form-fitting and non-rotatable and/or material bonded and non-rotatable manner.

9. The fluid pump according to claim 7, wherein the center part is formed from a sliding bearing material and the bearing is integrally formed in the center part.

10. The fluid pump according to claim 7, wherein on the impeller, facing away from the rotor, at the face end at least one assembly recess is formed which is orientated parallel to and arranged spaced from the axis of rotation of the rotor.

11. The fluid pump according to claim 1, wherein the fluid pump is an electric liquid pump.
